(19) United States
(12) Patent Application Publication
(10) Pub. No.: US 2024/0024961 A1
(43) Pub. Date: Jan. 25, 2024

(54) HYDRAULIC CHUCK AND EXPANSION SLEEVES

(71) Applicant: Kennametal Inc., Latrobe, PA (US)

(72) Inventors: Santosh B. Boregowda, Bangalore (IN); Ruy Frota de Souza Filho, Latrobe, PA (US); Dominik Schmid, Furth (DE); Michael Schuffenhauer, Furth (DE); Josef Herud, Herzogenaurach (DE)

(21) Appl. No.: 17/871,530

(22) Filed: Jul. 22, 2022

(51) Int. Cl. B23B 31/30

(52) U.S. Cl. CPC B23B 31/305

(57) ABSTRACT

Expansion sleeves are disclosed comprising a body and a flange. The body may be generally cylindrical and includes an inner wall, an outer wall integrally formed with the inner wall, and a pressurized fluid chamber located radially between and encapsulated in the inner wall and the outer wall. The front flange extends radially outward from the outer wall of the body. The front flange may comprise a tool support connection structured and arranged to fasten the front flange to a tool support member. The tool support member may include a pressurized fluid system that communicates with the pressurized fluid chamber of the expansion sleeve. The expansion sleeves may be secured to the tool support member by mechanical fasteners, threading, or combinations thereof. During operation, pressurized fluid in the tool support member communicates with the pressurized fluid chamber of the expansion sleeve to clamp a tool shank.

### FIELD OF THE INVENTION

The present invention relates to hydraulic chucks, and more particularly relates to closed chamber sleeves for hydraulic chucks.

### BACKGROUND INFORMATION

Chucks are designed to securely hold objects, such as tool shanks. A hydraulic chuck comprises a center cylindrical bore designed to clamp a tool shank. A cylindrical sleeve designed to hold tool shanks is received in the center cylindrical bore and soldered in place. The sleeve comprises a pressure chamber comprising a hydraulic fluid, such as oil. A pressurized member, such as a screw, communications with the oil to pressurize the oil when the screw is advanced. When the oil is pressurized, the sleeve clamps a tool shank. Over time, the pressure creates cracks in soldering, causing catastrophic failure of tools.

### SUMMARY OF THE INVENTION

The present invention provides expansion sleeves for receiving tool shanks. The expansion sleeve comprises a generally cylindrical body defining a longitudinal axis and a front flange. The body comprises an inner wall, an outer wall integrally formed with the inner wall, and a pressurized fluid chamber located radially between and encapsulated in the inner wall and the outer wall. The front flange extends radially outward from the outer wall of the body, and comprises a tool support connection structured and arranged to fasten the front flange to a tool support member. The tool support member may include a pressurized fluid system that communicates with the pressurized fluid chamber of the expansion sleeve. The expansion sleeves may be secured to the tool support member by brazing, mechanical fasteners, threading, or combinations thereof. During operation, a pressure adjustment screw in the tool support member communicates with the pressurized fluid chamber of the expansion sleeve to clamp a tool shank.

The present invention also provides a hydraulic chuck assembly comprising a tool support member, and an expansion sleeve inserted in the tool support member. The expansion sleeve comprises a generally cylindrical body comprising an inner wall, an outer wall integrally formed with the inner wall, and a pressurized fluid chamber located radially between and encapsulated in the inner wall and the outer wall, and a front flange extending radially outward from the outer wall, wherein the front flange comprises a tool support connection structured and arranged to fasten the front flange to the tool support member. The cylindrical body defines a longitudinal axis.

### BRIEF DESCRIPTION OF THE DRAWINGS

FIG. 1 is a front isometric view of an expansion sleeve in accordance with an embodiment of the present invention.

FIG. 2 is a rear isometric view of the expansion sleeve of FIG. 1.

FIG. 3 is a top view of a hydraulic chuck assembly comprising a tool support member and the expansion sleeve of FIGS. 1-2.

FIG. 4 is a side, partial sectional view of the hydraulic chuck assembly of FIG. 3.

FIG. 5 is a front isometric view of a hydraulic chuck assembly.

FIG. 6 is a front isometric view of an additional expansion sleeve, in accordance with an embodiment of the present invention.

FIG. 7 is a rear isometric view of the expansion sleeve of FIG. 6.

FIG. 8 is a top view of an additional hydraulic chuck assembly comprising a tool support member and the expansion sleeve of FIGS. 6-7.

FIG. 9 is a side, partial sectional view of the hydraulic chuck assembly of FIG. 8.

FIG. 10 is an enlarged view of a portion of the pressurized fluid system of the hydraulic chuck assembly of FIG. 9.

FIG. 11 is a side, partial sectional view of an additional hydraulic chuck assembly comprising a tool support member and an expansion sleeve according to an embodiment of the present invention.

FIG. 12 is a front isometric view of an additional expansion sleeve, in accordance with an embodiment of the present invention.

FIG. 13 is a side, partial sectional view of an additional hydraulic chuck assembly comprising a tool support member and an expansion sleeve according to an embodiment of the present invention.

FIG. 14 is a front isometric view of an additional expansion sleeve, in accordance with an embodiment of the present invention.

FIG. 15 is a rear isometric view of the expansion sleeve of FIG. 14.

FIG. 16 is a top view of an additional hydraulic chuck assembly comprising a tool support member and the expansion sleeve of FIGS. 14-15.

FIG. 17 is a side, partial sectional view of the hydraulic chuck assembly of FIG. 16.

FIG. 18 is a front isometric view of an additional expansion sleeve, in accordance with an embodiment of the present invention.

FIG. 19 is a rear isometric view of the expansion sleeve of FIG. 18.

FIG. 20 is a top view of the expansion sleeve of FIGS. 18-19.

FIG. 21 is a side, partial sectional view of an additional hydraulic chuck assembly comprising a tool support member and the expansion sleeve of FIGS. 18-20.

FIG. 22 is a front isometric view of an additional expansion sleeve, in accordance with an embodiment of the present invention.

FIG. 23 is a rear isometric view of the expansion sleeve of FIG. 22.

FIG. 24 is a top view of an additional hydraulic chuck assembly comprising a tool support member and the expansion sleeve of FIGS. 22-23.

FIG. 25 is a side, partial sectional view of the hydraulic chuck assembly of FIG. 24.

FIG. 26 is a side sectional view of a ball seal for sealing a pressurized fluid supply line, in accordance with an embodiment of the present invention.

FIG. 27 is a side sectional view of a pressure chamber including a radially extending secondary chamber, in accordance with an embodiment of the present invention.

FIG. 28 is a rear isometric view of an additional expansion sleeve, in accordance with an embodiment of the present invention.

FIG. 29 is a top view of a tool support member that is structured and arranged to receive the expansion sleeve of FIG. 28.

FIG. 30 is a bottom view of an additional hydraulic chuck assembly comprising the expansion sleeve of FIG. 28.

FIG. 31 is a partial sectional view of the hydraulic chuck assembly of FIG. 30.

FIG. 32 is an enlarged view of a portion of the pressurized fluid system of the hydraulic chuck assembly of FIG. 31.

### DETAILED DESCRIPTION

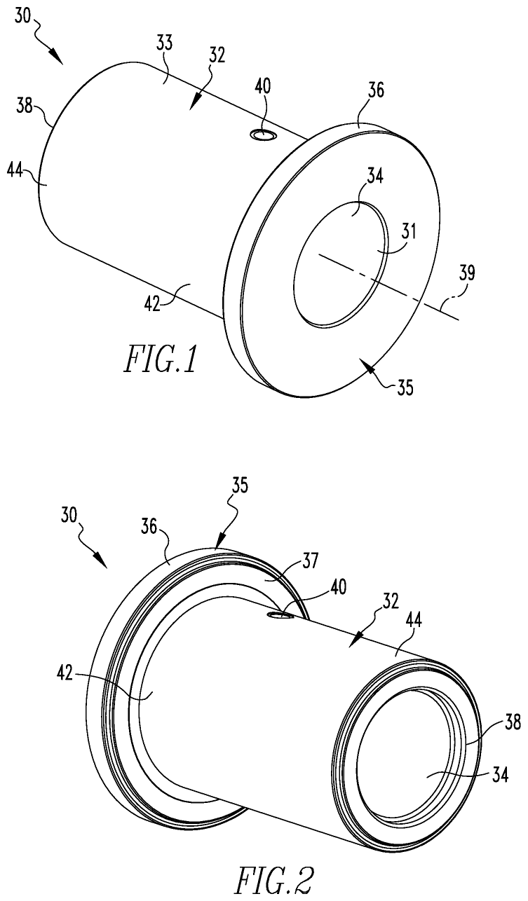

FIGS. 1-2 illustrate an expansion sleeve 30 in accordance with an embodiment of the present invention. The expansion sleeve 30 includes a cylindrical body 32 defines a longitudinal axis 39, and has an axial forward end 42 and an axial rearward end 44 along a longitudinal axis 39 of the sleeve 30. A tool holder receptacle opening 31 is provided at the forward end 42. A radial outer wall 33 having an outer surface and a clamping inner wall 34 having an inner surface extend between the axial forward end 42 and the axial rearward end 44. The clamping inner surface of the inner wall 34 extends to the tool holder receptacle opening 31 at the forward end 42 of the expansion sleeve 30. The expansion sleeve 30 includes a front flange 35 adjacent the axial forward end 42 of the cylindrical body 32. The front flange 35 has a radial outer edge 36 and a rear face 37. The sleeve 30 has a rear edge 38 adjacent the axial rearward end 44. The cylindrical body 32 has a pressurized hydraulic fluid inlet port 40 extending through the radial outer surface of the outer wall 33, as more fully described below.

The outer wall 33 is integrally formed with the inner wall 34. As used herein, the terms “integral” and “integrally formed,” when referring to the expansion sleeve 30, mean that the outer and inner walls 33 and 34 are fabricated as a single unitary piece and without being produced from separate parts that are subsequently joined together by methods such as welding, brazing or the like. The integrally formed outer and inner walls 33 and 34 may be produced together at the same time as a unitary structure by any suitable process such as additive manufacturing, lost wax casting and the like.

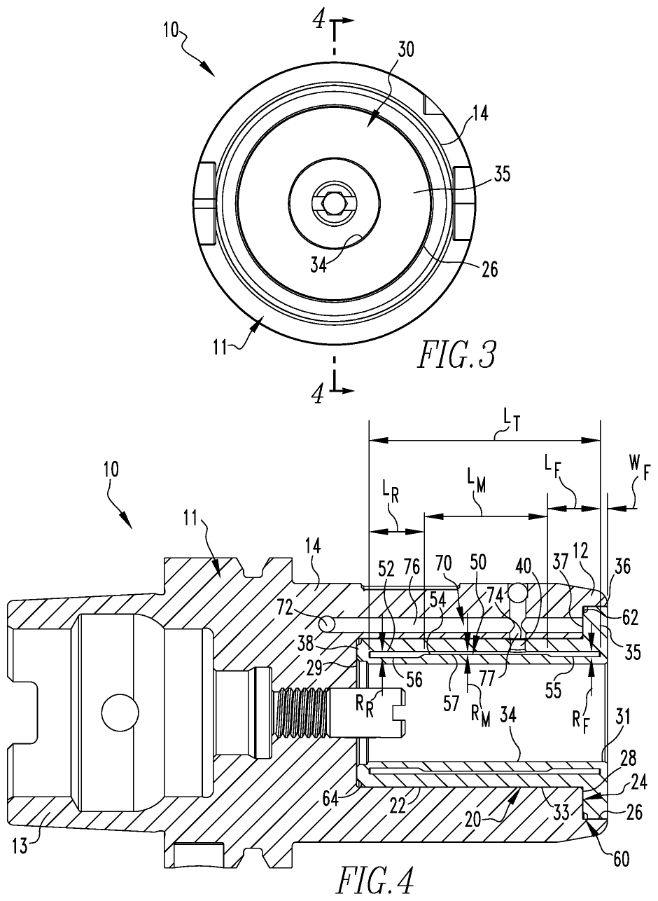

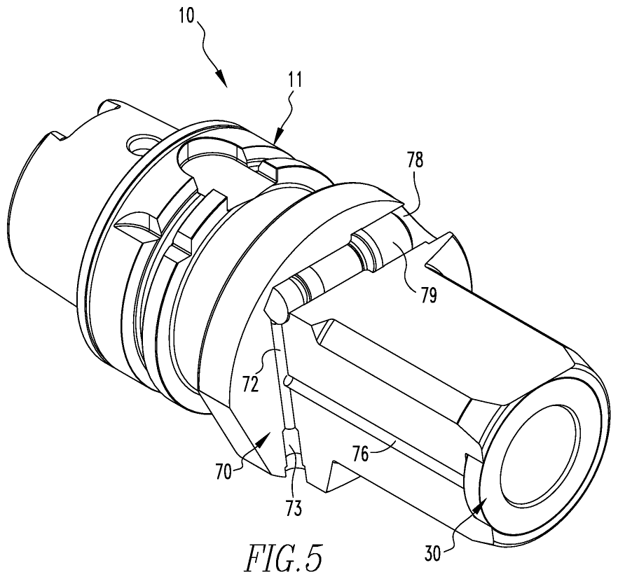

FIGS. 3 and 4 illustrate a hydraulic chuck assembly 10 comprising the expansion sleeve 30 shown in FIGS. 1 and 2 and a tool support member 11 that receives the expansion sleeve 30. The tool support member 11 has a tool receptacle front end 12 and a machine-tool rear end 13. The tool support member 11 has a body 14 extending radially between the tool receptacle front end 12 and the machine-tool rear end 13. The hydraulic chuck assembly 10 is secured to a machine tool by means of a threaded central bolt.

An axial bore 20 located at the tool receptacle front end 12 is configured to receive the expansion sleeve 30. The axial bore 20 has a generally cylindrical inner surface 22 that contacts and holds the expansion sleeve 30, as more fully described below. The axial bore 20 has a bottom 29 located toward the machine-tool rear end 13 of the tool support member 11. The axial bore 20 transitions to an annular front recess 24 toward the tool receptacle front end 13 of the tool support member 11. The annular front recess 24 has an inner radial surface 26 and a front face 28. The expansion sleeve 30 comprises a cylindrical body 32 and a front flange 35. The cylindrical body 32 comprises a clamping inner surface of the inner wall 34. The clamping inner surface of the inner wall 34 extends to the tool holder receptacle opening 31 at the forward end 42 of the expansion sleeve 30. The inner radial surface 26 of the annular front recess 24 contacts the radial outer edge of the front flange 35 and the front face of the annular front recess 28 contacts a rear face 37 of the front flange 35.

The expansion sleeve 30 has an internal pressure chamber 50 located between the outer radial surface 33 and the inner clamping surface 34. The pressure chamber 50 has a generally cylindrical outer radial wall surface 52 and a generally cylindrical inner radial wall surface 54. As shown in FIG. 4, the pressure chamber 50 has a total axial length L_{T}. In the embodiment shown, the generally cylindrical inner radial wall 54 has a recessed front section 55 having an axial length L_{F} and a radial width R_{F}, a recessed rear section 56 having an axial length L_{R} and a radial width R_{R}, and a raised midsection 57 having an axial length L_{M} and a radial width R_{M}. The relatively thin recessed sections 55 and 56 are able to deform to a greater extent than the thicker midsection 57 when the internal pressure chamber 50 is pressurized by hydraulic fluid. This causes the midsection 57 to flex inwardly and provide increased clamping force on a tool shank in the midsection region. The raised midsection 57 can be relatively long because the integrally formed outer and inner walls 33 and 34 are made of a single unitary piece of material and no braze or other type of joint is required in communication with or adjacent to the pressure chamber 50. The lengths of the recessed sections 55 and 56, L_{F} and L_{R}, may be minimized so that the majority of the length L_{M} of the pressure chamber at the midsection 57 provides clamping force on the tool shank, thus improving clamp stability.

As shown in FIG. 4, the length of the midsection L_{M} may be greater than the length of the rear section L_{R}, or may be greater than the length of the front section L_{F}, or may be greater than the combined lengths L_{R} and L_{F}. For example, the ratio of L_{M}:L_{R} may be from 1.5:1 to 20:1, or from 2:1 to 10:1. The ratio of L_{M}:L_{F} may be 1.5:1 to 20:1, or from 2:1 to 10:1. The ratio of L_{R}:L_{F} may be from 0.5:1 to 2:1, or from 0.8:1 to 1.2:1. The ratio of L_{M}:L_{T} may be from to 1:1, or from 0.3:1 to 0.95:1, or from 0.4:1 to 0.8:1.

The radial widths R_{F} and R_{R} of the recessed front and rear sections 55 and 56, respectively, may be from zero to 1,000 percent greater than the radial width R_{M} of the raised midsection 57, for example, from 50 to 500 percent greater, or from 100 to 300 percent greater. R_{F} and R_{R} may typically be from 0.1 to 1 mm, for example from 0.2 to 0.8 mm, or from 0.4 to 0.6 mm.

As further shown in FIG. 4, the front section 55 of the pressure chamber 50 terminates at a location relatively close to the front surface of the flange 35, measured by a face width W_{F}. The face width W_{F} may typically be from 0.5 to 6 mm, for example, from 0.8 to 5 mm, or from 1 to 4 mm. In certain embodiments, the face width W_{F} may be less than 5 mm, or less than 4 mm, or less than 3 mm, or less than 2 mm, or less than 1 mm. In the embodiment shown, the face width W_{F} is less than the axial thickness of the front flange 35, such that the pressure chamber 50 extends forwardly into the flange, for example, the front section 55 extends axially into the flange 35 at least 20 percent, or at least 33 percent, or at least 50 percent, or at least 66 percent of the axial thickness of the flange 35.

The ratio of W_{F}:R_{F} may typically range from 1:1 to 20:1, or from 1.5:1 to 15:1, or from 2:1 to 10:1. The ratio of W_{F}:L_{T} may typically range from 0.005:1 to 0.5:1, or from 0.01:1 to 0.2:1, or from 0.02:1 to 0.1:1.

As further shown in FIG. 4, the expansion sleeve 30 is fastened to the tool support member 11 by a sleeve connection 60 including a front braze ring 62 and a rear braze ring 64. The front braze ring 62 is located at the radial outer edge 36 and at the rear face 37 of the front flange 35. The front braze ring 62 is also located in the annular front recess 24 of the tool support member 11, at the intersection of the inner radial surface 26 and front face 28 of the annular front recess 24. The rear braze ring 64 is located at the rear edge 38 of the expansion sleeve 30 adjacent to the radial outer surface 33. The rear braze ring 64 is also located at the bottom 29 of the axial bore 20 adjacent to the inner surface 22 of the axial bore 20.

The present invention advantageously provides an enclosed pressure chamber 50. Because the pressure chamber 50 is enclosed, the pressure is not placed on a brazing joint, which can lead to cracking of soldering joints over time and catastrophic tool failure. An expansion sleeve is releasably attached to a tool support member so as to secure the expansion sleeve to the tool support member for operation of the hydraulic chuck assembly while allowing for removal of the expansion sleeve for replacement or repair as may be desired. Various means of attaching the expansion sleeve to the tool support member are discussed herein. In an embodiment of the present invention, the expansion sleeve 30 is attached to the tool support member 11 by way of brazing at the front braze ring 62 and the rear braze ring 64. The brazing is located away from the pressure chamber 50 so that direct pressure is not placed upon the brazing joints, providing a more wear-resistant expansion sleeve 30.

As shown in the hydraulic chuck assembly 10 shown in FIGS. 4 and 5, the tool support member 11 includes a pressurized fluid system 70 that supplies hydraulic fluid to a pressure chamber 50 of the expansion sleeve 30. Hydraulic fluid may be introduced to the pressurized fluid system 70 through a pressurized fluid supply inlet 72 which communicates with a first pressurized fluid line 76. The first pressurized fluid line 76 communicates with a second pressurized fluid line 77. The fluid moves through the second pressurized fluid line 77 to a pressurized fluid supply outlet 74. The pressurized fluid supply outlet 74 is in communication with the inlet port 40 of the expansion sleeve 30, through which hydraulic fluid is introduced into the pressure chamber 50 housed in the expansion sleeve 30. The pressurized fluid supply inlet 72 may be sealed in any manner known in the art, including but not limited to an expansion plug or a press ball.

FIG. 5 is a partially cutaway isometric view illustrating the pressurized fluid system 70. Hydraulic fluid is introduced into the pressurized fluid system 70 through the pressurized fluid fill port 73 into the pressurize fluid supply inlet 72. The hydraulic fluid travels from the pressurized fluid supply inlet 72 to the first pressurized fluid line 76. A pressure adjustment bore 78 is in communication with the pressurized fluid system 70. A pressure adjustment screw 79 is inserted into the pressure adjustment bore 78. The pressure adjustment screw 79 regulates the pressure in the pressure chamber. When the screw is tightened, high pressure builds up in the pressure chamber 50. As a result of this pressure, the expansion sleeve 30 is actuated inward elastically in a radial direction for chucking a tool.

In some embodiments, the expansion sleeve may be made of a harder material than the tool support member, such as carbide steel. The tool support member may typically be made of, for example, steel or suitable like materials. The harder material of the expansion sleeve may provide increased stiffness and hardness, thus making the system more wear-resistant. In other embodiments, the expansion sleeve may be made of a material having low thermal conductivity, such as stainless steel or ceramic. This provides for a sleeve with lower thermal conductivity, which may prevent unwanted heating of the hydraulic fluid in the pressurized fluid system.

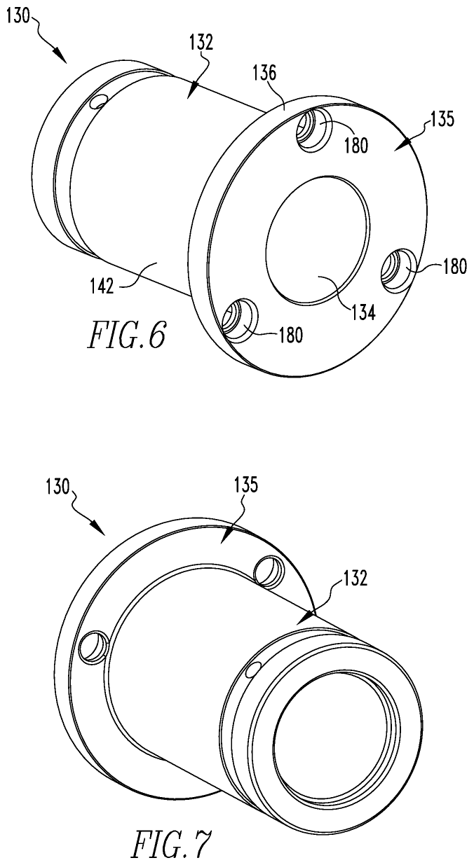

FIGS. 6-7 illustrate an expansion sleeve 130 in accordance with another embodiment of the present invention. The expansion sleeve 130 includes several features similar to the expansion sleeve 30. Features common to the embodiments described herein are labeled with the same element numbers. The expansion sleeve 130 includes a cylindrical body 132 and a front flange 135 adjacent the axial forward end 142 thereof. The front flange 135 defines three attachment screw bores 180 and has a radial outer edge 136. The expansion sleeve further comprises a clamping inner surface 134.

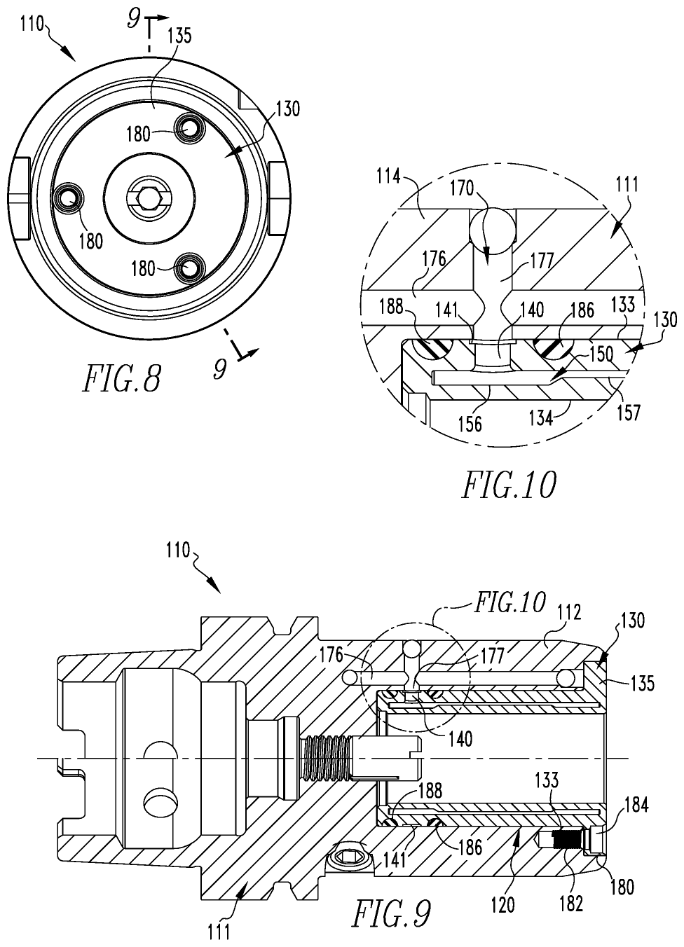

FIG. 8 illustrates a hydraulic chuck assembly 110 comprising the expansion sleeve 130 of FIGS. 6-7 in accordance with an embodiment of the present invention. The expansion sleeve 130 comprises the front flange 135, which defines three attachment screw bores 180.

FIG. 9 illustrates the hydraulic chuck assembly 110 of FIG. 8 comprising a tool support member 111 and the expansion sleeve 130 of FIGS. 6-7 in accordance with an embodiment of the present invention. In this embodiment, the tool support connection comprises multiple bolt screws or other types of mechanical fasteners extending through the front flange 135 into the tool support member 111. An attachment screw bore 180 is adjacent the tool receptacle front end 112 in communication with the axial bore 120. An attachment screw 182 having an attachment screw flange 184 is inserted into the attachment screw bore 180. In an embodiment, the attachment screw 182 and the attachment screw flange 184 releasably attach the expansion sleeve 130 and the tool support member 111. A pressurized hydraulic fluid inlet port 140 of the expansion sleeve 130 is adjacent the second pressurized fluid line 177, which is in fluid communication with the first pressurized fluid line 176.

As shown in FIGS. 9 and 10, an annular recessed fluid channel 141 extends radially from the inlet port 140 of the expansion sleeve 130. A ring-shaped front radial seal 186 extends radially around the radial outer surface of the outer wall 133 of the expansion sleeve 130 forward of the inlet port 140. A ring-shaped rear radial seal 188 extends radially around the radial outer surface of the outer wall 33 rearward of the inlet port 140. The front and rear seals 186 and 188, respectively, may be made of any suitable materials including elastomeric polymers, rubbers and the like. The pressure chamber 150 is located between the outer radial surface 133 and the inner clamping surface 134 of the expansion sleeve 130. Hydraulic fluid is introduced through a pressurized fluid system 170 through the pressurized hydraulic fluid inlet port 140 into the recessed rear section 156 of the pressure chamber 150. The raised midsection 157 of the pressure chamber 150 extends from the recessed rear section 156 of the pressure chamber 150.

FIG. 10 illustrates an enlarged view of the pressurized fluid system 170 located in the body 114 of the tool support member 111 in the embodiment of the present invention shown in FIG. 9. The first pressurized fluid line 176 is in fluid communication with the second pressurized fluid line 177. Hydraulic fluid is introduced into the pressure chamber 150 through the inlet port 140 and annular recessed fluid channel 141. The radial seals 186 and 188 extend radially around the radial outer surface 133 of the expansion sleeve 130 in order to prevent leaking of the hydraulic fluid.

FIG. 11 illustrates a hydraulic chuck assembly 210 comprising a tool support member 211 and an expansion sleeve 230 similar to the expansion sleeve 130 of FIGS. 6-7 in accordance with an embodiment of the present invention. A radial outer surface 233 of the expansion sleeve 230 is tapered inward along a longitudinal axis 239 of the expansion sleeve 230 from the front flange 235 toward a rear edge 238 of the expansion sleeve 230. The radial outer surface 233 of the expansion sleeve 230 is tapered at an angle of 1° to 6°. An inner surface 222 of an axial bore 220 of the tool support member 211 is tapered inward along the longitudinal axis 239 of the expansion sleeve 230 from the tool receptacle front end 212 to the bottom of the axial bore 229. The inner surface 222 of the axial bore 220 is tapered at an angle of 1° to 6°. The tapering of the attachment screw bore 270 provides a tighter securement of the expansion sleeve 230. The taper angles of the outer surface of the sleeve and the inner surface of the axial bore may be the same or slightly different, that is, they may differ by a maximum of 0.25°.

In the embodiments described herein, any suitable fit or tolerance may be provided between the tool support member and the expansion sleeve. Typically, an interference fit, press fit, and/or friction fit may be provided between the radial outer surface of the cylindrical body of the expansion sleeve and the inner surface of the axial bore of the tool support member when the expansion sleeve is inserted into the axial bore. For example, in the embodiment shown in FIG. 11, an interference fit may be provided between the tapered surface 222 of the axial bore 220 and the tapered radial outer surface 233 of the expansion sleeve 230 that may help transmit torque between the tool support member 211 and the expansion sleeve 230. Such an interference fit may provide compressive stress to the expansion sleeve, which may reduce or prevent failures due to fatigue cracks and/or allow higher pressures to be used. Similarly, a press fit may be provided between cylindrical bodies of expansion sleeves and axial bores of the tool support member having cylindrical surfaces.

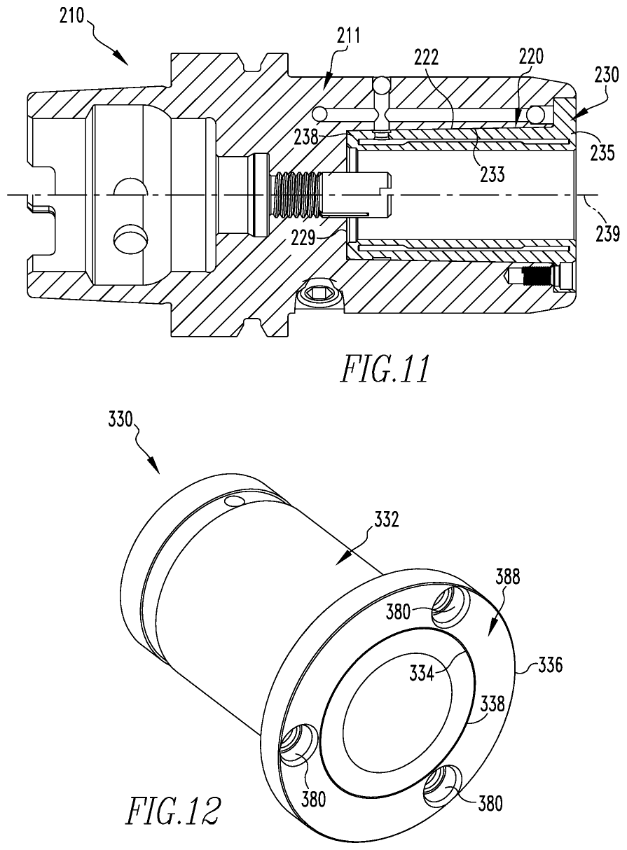

FIG. 12 illustrates an expansion sleeve 330 in accordance with an embodiment of the present invention. The expansion sleeve 330 comprises a cylindrical body 332 and a separate retaining ring 388 comprising an outer edge 336 and a radial inner diameter 338. The radial inner diameter 338 contacts the annular recessed front shoulder 334. The retaining ring 388 defines three attachment screw bores 380.

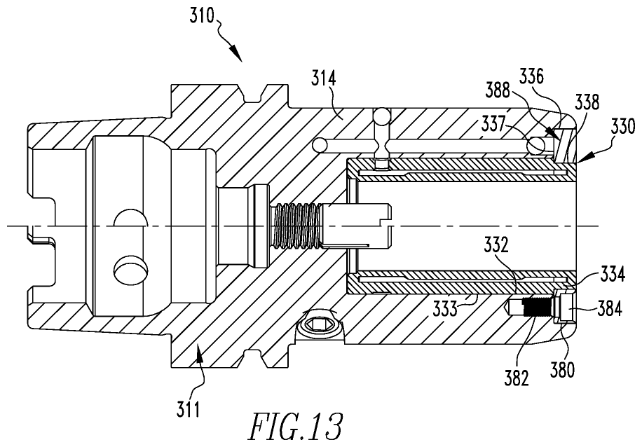

FIG. 13 illustrates a hydraulic chuck assembly 310 comprising a tool support member 311 comprising a body 314 and the expansion sleeve 330 of FIG. 12 comprising a cylindrical body 332 and a retaining ring 388, in accordance with an embodiment of the present invention. The retaining ring 388 comprises a back rear face 337, an outer edge 336, and a radial inner diameter 338. The retaining ring 388 defines an attachment screw bore 380. An attachment screw 382 having an attachment screw flange 384 is inserted into the attachment screw bore 380. In an embodiment, the attachment screw 382 and the attachment screw flange 384 releasably attach the expansion sleeve 330 and the tool support member 311.

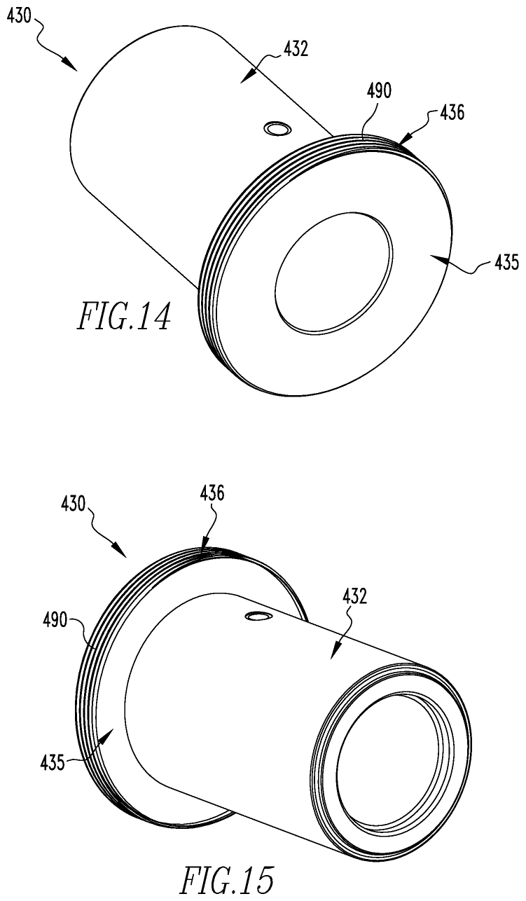

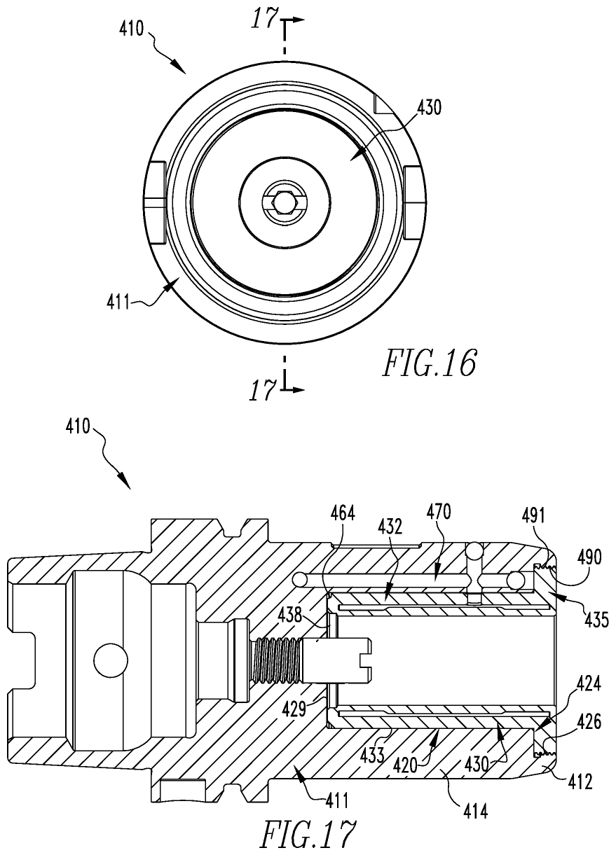

FIGS. 14-15 illustrate an expansion sleeve 430 in accordance with an embodiment of the present invention. The expansion sleeve 430 comprises a cylindrical body 432 and a front flange 435. External threads 490 extend radially along the outer radial surface 436 of the front flange 435.

FIG. 16 illustrates a hydraulic chuck assembly 410 comprising a tool support member 411 and the expansion sleeve of FIGS. 14-15 in accordance with an embodiment of the present invention.

FIG. 17 illustrates the hydraulic chuck assembly 410 of FIG. 16 comprising a tool support member 411 and the expansion sleeve 430 of FIGS. 14-16 in accordance with an embodiment of the present invention. The tool support member 411 includes a pressurized fluid system 470. The expansion sleeve 430 comprises a cylindrical body 432 and a front flange 435. The front flange 435 is housed in the axial bore 420 at the tool receptacle front end 412 of the tool support member 411. The external threads 490 of the front flange 435 are shown. In an embodiment, the tool support connection comprises the external threads 490 threadingly engaged with internal threads 491 on the inner radial surface 426 of the annular front recess 424 in the body 414 of the tool support member 411. A rear braze ring 494 is located at the rear edge 438 of the expansion sleeve 430 adjacent to the radial outer surface 436. The rear braze ring 464 is also located at the bottom 429 of the axial bore 420 adjacent to the inner radial surface 426.

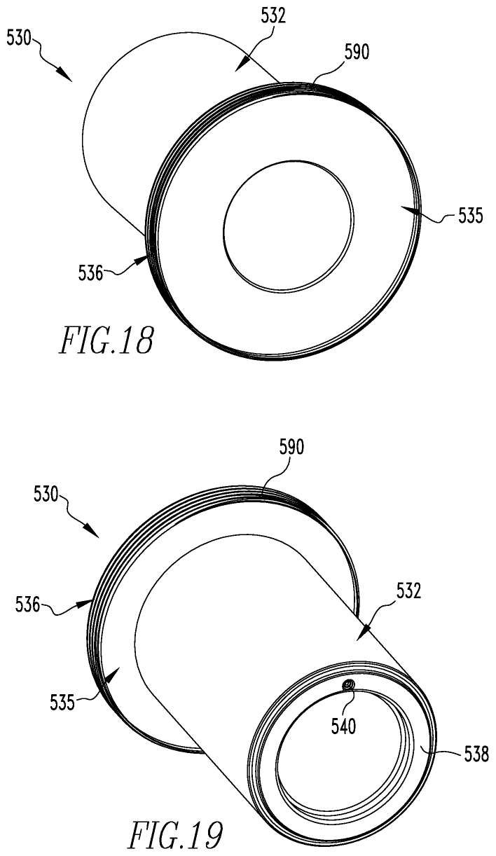

FIGS. 18-19 illustrate an expansion sleeve 530 in accordance with an embodiment of the present invention. The expansion sleeve 530 comprises a cylindrical body 532 and a front flange 535. External threads 590 extend radially on the radial outer surface 533 of the front flange 535. In an embodiment, the pressurized hydraulic fluid inlet port 540 is housed on the rear edge 538 of the expansion sleeve 530.

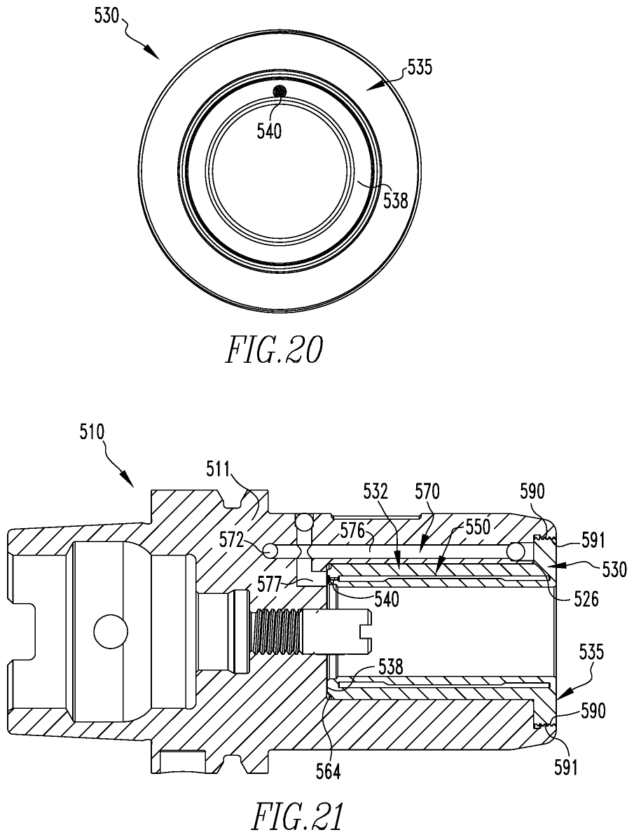

FIG. 20 illustrates a top view of the expansion sleeve 530 of FIGS. 18-19. The expansion sleeve comprises the front flange 535 and the rear edge 538. The inlet port 540 is housed on the rear edge 538 of the expansion sleeve 530.

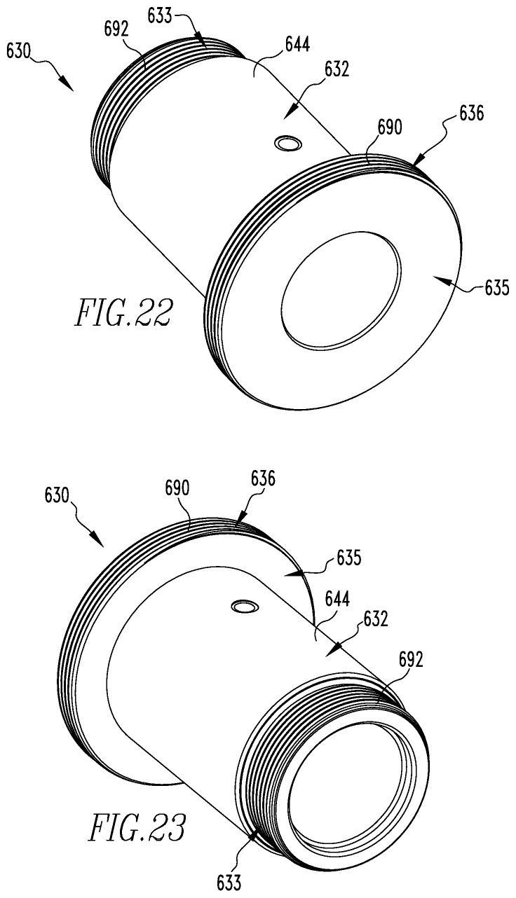

FIG. 21 illustrates a hydraulic chuck assembly 510 comprising a tool support member 511 and the expansion sleeve 530 of FIGS. 18-20. The expansion sleeve 530 comprises a cylindrical body 532 and a front flange 535. The tool support connection in this embodiment comprises external threads 590 of the front flange 535 and internal threads 591 of the inner radial surface 526, similar to the external threads 490 and internal threads 491. The tool support connection further comprises a rear braze ring 564, similar to 464. The hydraulic chuck assembly 510 comprises a pressurized fluid system 570. The pressurized fluid system 570 comprises a pressurized fluid supply inlet 572, through which hydraulic fluid is introduced into the pressurized fluid system. The pressurized fluid supply inlet 572 communicates with the first pressurized fluid line 576 and the second pressurized fluid line 577. The inlet port 540 is housed on the rear edge 538 of the expansion sleeve 530. Hydraulic fluid moves through the second pressurized fluid line 577 and the inlet port 540 and into the pressure chamber 550.

FIGS. 22-23 illustrate an expansion sleeve 630 in accordance with an embodiment of the present invention. External threads 690 extend radially on the outer surface 636 of the front flange 635. A second set of external threads 692 extends radially on the radial outer surface 633 of the cylindrical body 632 adjacent the axial rearward end 644.

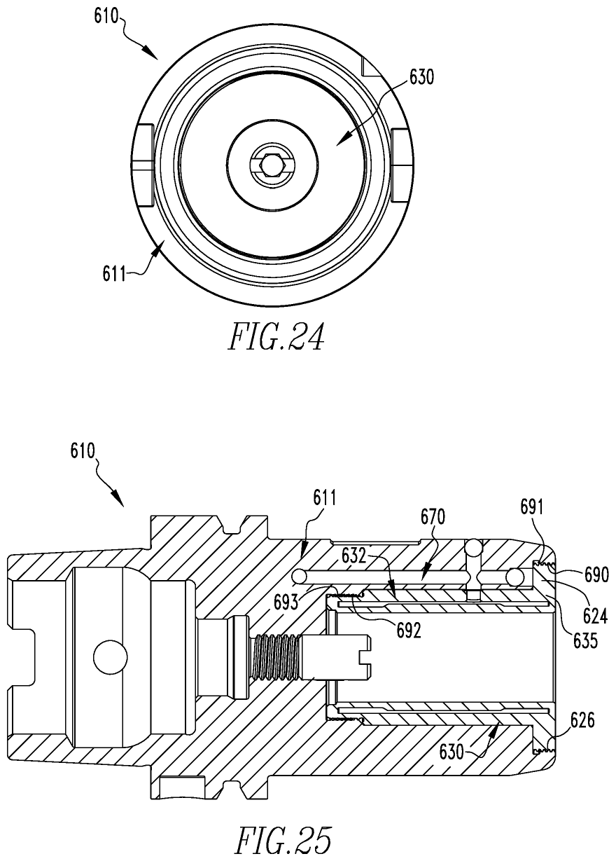

FIG. 24 illustrates a hydraulic chuck assembly 610 comprising a tool support member 611 and the expansion sleeve 630 of FIGS. 22-23 in accordance with an embodiment of the present invention.

FIG. 25 illustrates the hydraulic chuck assembly 610 of FIG. 24 comprising a tool support member 611 and the expansion sleeve 630 of FIGS. 22-23 in accordance with an embodiment of the present invention. The tool support member includes a pressurized fluid system 670. The expansion sleeve 630 comprises a cylindrical body 632 and a front flange 635. External threads 690 extending radially along the outer edge of the front flange 635 communicate threadingly with the internal threads 691 of the inner radial surface 626 of the annular front recess 624. The second set of external threads 692 communicate threadingly with the second set of internal threads 693.

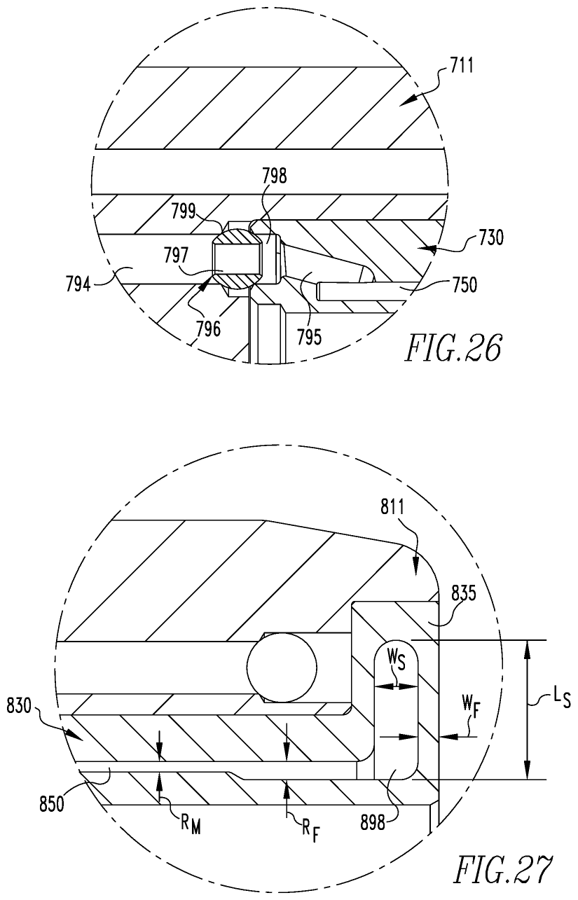

FIG. 26 illustrates a tool support member 711 and an expansion sleeve 730 similar to the tool support members and expansion sleeves described above, with a ball seal 796 having a central bore 797 located between the expansion sleeve 730 and an oil connection bore 794 of the tool support member 711. The oil connection bore 794 may be of similar construction as the second pressurized fluid line 577 of FIG. 21. An oil connection notch 795 extends into the expansion sleeve 730 and communicates with the pressure chamber 750. A seating recess 798 is in communication with the oil connection notch 795. A seating bevel 799 at the end of the oil connection bore 794 receives the ball seal 796. The ball seal 796 is seated between the oil connection bore 794 and oil connection notch 795, with the central bore 797 allowing fluid communication therebetween. The ball seal 796 may be compressed and plastically deformed to form a seal that prevents pressurized fluid from escaping. The ball seal 796 may be made of metal such as stainless steel, ceramic, hard plastic, or the like. When made of metal, the ball seal 796 may provide metal-to-metal sealing.

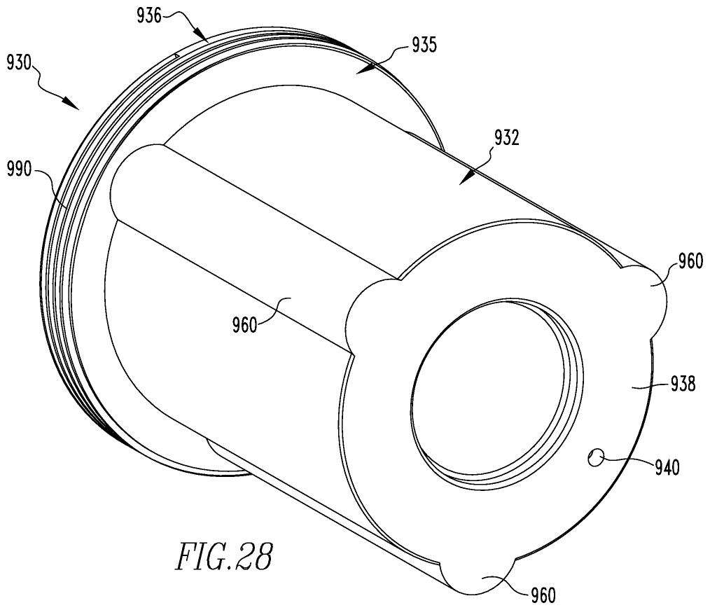

FIG. 27 illustrates an embodiment of a primary pressure chamber 850 of an expansion sleeve 830, which is housed in a tool support member 811. The primary pressure chamber 850 extends parallel with the longitudinal axis and communicates with a secondary chamber 898 forming an L-shape that extends radially outward from the primary pressure chamber 850 into the front flange 835. The secondary chamber 898 may extend radially outward in a direction perpendicular to the primary chamber 850, or in a non-perpendicular direction. During fabrication of the expansion sleeve 830, the secondary chamber 898 may be formed at the same time the primary chamber 850 is formed during the integral formation of the outer and inner walls of the expansion sleeve 830, for example, by additive manufacturing. The length of the secondary chamber L_{S} and the width of the secondary chamber W_{S} are shown. The ratio of L_{S}:W_{S} may typically be from 1:1 to 10:1, or from 2:1 to 5:1. The ratio of L_{S}:R_{F} may typically be from 2:1 to 20:1 or from 3:1 to 10:1. The ratio of W_{S}:R_{F} may typically be from 1:1 to 15:1, or from 1.5:1 to 10:1, or from 2:1 to 8:1. The ratio of W_{F}:W_{S} may typically be from 0.1:1 to 2:1, or from 0.2:1 to 1:1, or from 0.3:1 to 0.8:1. W_{S} may typically range from 0.3 to 5 mm, or from 0.5 to 4 mm, or from 1 to 3 mm. The ratio of W_{F}:R_{F} may typically range from 1:1 to 20:1, or from 1.5:1 to 15:1, or from 2:1 to 10:1, and W_{F} may typically be from 0.5 to 6 mm, or from 0.8 to 5 mm, or from 1 to 4 mm.

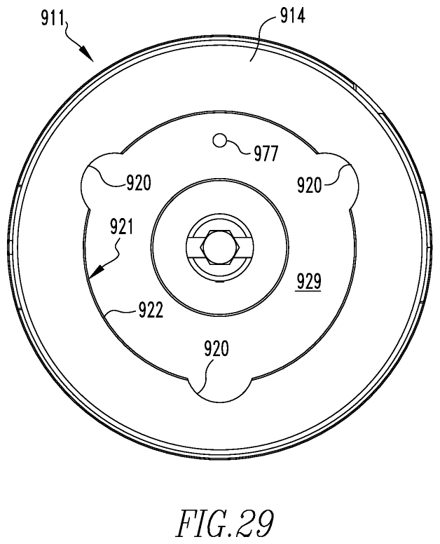

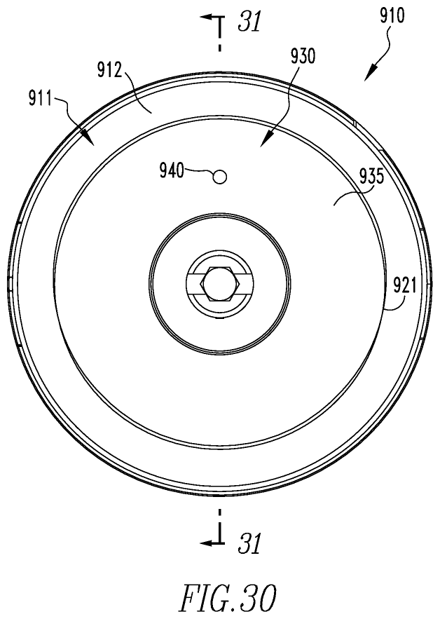

FIG. 28 illustrates an expansion sleeve 930 that may be inserted in a tool support member 911 shown in FIG. 29 in accordance with an embodiment of the present invention. The expansion sleeve 930 comprises a cylindrical body 932 and a separate retaining ring 935. The cylindrical body 932 comprises anti-rotation ribs 960. In the embodiment shown, the expansion sleeve 930 comprises three anti-rotation ribs 960 at equal circumferential spacings. However, any other suitable number of anti-rotation rings and spacings may be used. The rear edge 938 of the expansion sleeve 930 contains an inlet port 940. External threads 990 extend radially along the outer radial surface of the retaining ring 935.

As shown in FIG. 29, the tool support member 911 comprises an axial bore 921 comprising a generally cylindrical inner surface 922 which contains anti-rotation channels 920 structured and arranged to receive the anti-rotation ribs 960 on the expansion sleeve 930 according to the embodiment shown in FIG. 28. In the embodiment shown, the generally cylindrical inner surface 922 contains three anti-rotation channels at equal circumferential spacings. However, any other suitable number of channels and spacings may be used. In addition, while in the embodiments shown in FIGS. 28 and 29 the anti-rotation channels 920 are provided in the axial bore 921 and anti-rotation ribs 960 are provided on the expansion sleeve 930, an opposite arrangement could be used in which at least one of the anti-rotation elements comprise a rib in an axial bore and a channel in an expansion sleeve. The bottom 929 of the axial bore 921 houses a first pressurized fluid line 977.

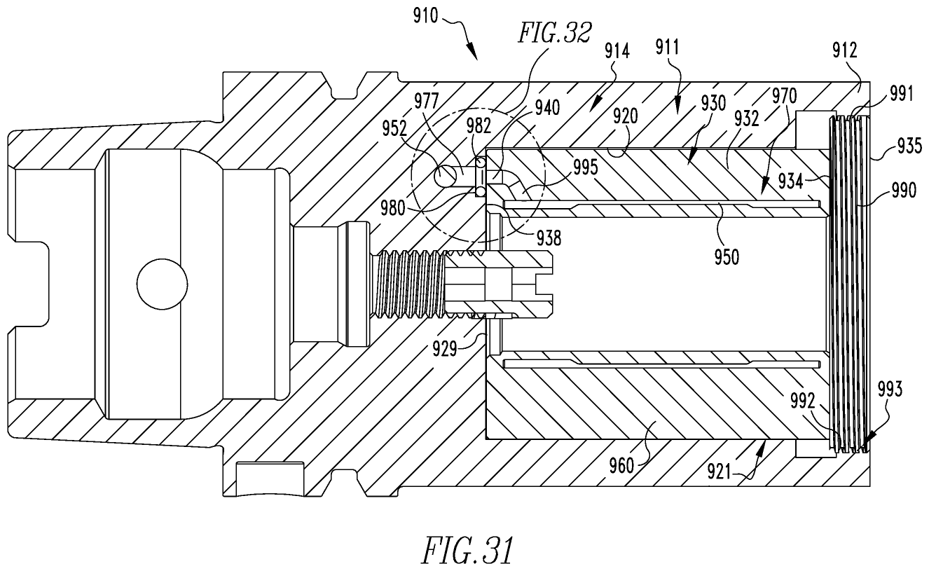

FIGS. 30 and 31 illustrate a hydraulic chuck assembly 910 including the expansion sleeve 930 of FIG. 28 and the tool support member 911 of FIG. 29. External threads 990 of the retaining ring 935 are threaded into internal threads 991 of an inner radial surface 992 of an annular front recess 993 of the body 914 of the tool support member 911. The retaining ring 935 is threaded until the retaining ring 935 contacts the front edge face 934 of the cylindrical body 932 of the expansion sleeve 930. The anti-rotation rib 960 of the expansion sleeve 930 is received in the anti-rotation channel 920 of the tool support member 911.

As shown in FIG. 31, the expansion sleeve 930 comprises a pressure chamber 950. Hydraulic fluid is supplied to the pressure chamber 950 through a pressurized fluid system 970. The pressurized fluid system 970 comprises a pressurized fluid supply inlet 952 through which hydraulic fluid may be introduced into the pressurized fluid system. The pressurized fluid supply inlet 952 communicates with a first pressurized fluid line 977. The first pressurized fluid line 977 extends through the bottom 929 of the axial bore 921 and communicates with an inlet port 940 of the expansion sleeve 930. The inlet port 940 extends through the rear edge 938 of the expansion sleeve 930. The inlet port 940 communicates with an oil connection notch 995. Hydraulic fluid may be supplied to the pressure chamber through the oil connection notch 995. A counter sunk annular recess 980 is located between the first pressurized fluid line 977 and the inlet port 940. A ring seal 982 is housed in the counter sunk annular recess 980.

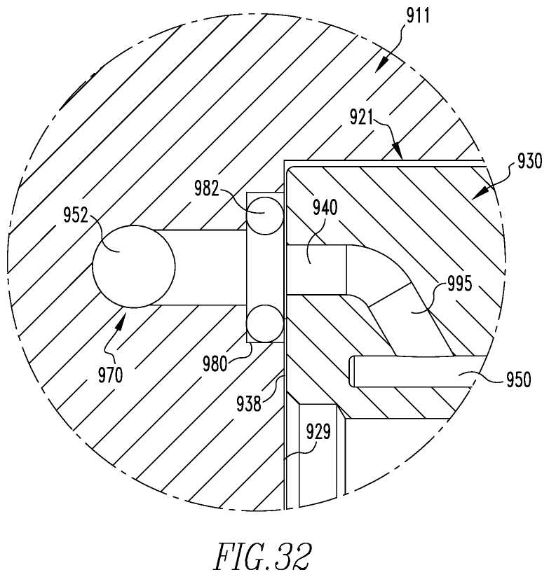

FIG. 32 is a magnified view of a portion of the pressurized fluid system 970 of FIG. 31. Hydraulic fluid is introduced into the pressurized fluid system 970 through the second pressurized fluid line 952 located in the tool support member 911. The second pressurized fluid line 952 extends through the bottom 929 of the axial bore 921. An inlet port 940 extends through the rear edge 938 of the expansion sleeve 930. The second pressurized fluid line 952 and the inlet port 940 are in fluid communication. A counter sunk annular recess 980 is located between the second pressurized fluid line 952 and the inlet port 940. The inlet port 940 is in communication with an oil connection notch 995, which is in communication with the pressure chamber 950 located in the expansion sleeve 930. A ring seal 982 is housed in the counter sunk annular recess 980, which may seal the pressurized fluid system once the hydraulic fluid is supplied to the pressure chamber.

The expansion sleeves and hydraulic chuck assemblies disclosed herein may be fabricated by any suitable methods, for example, by additive manufacturing. As understood by those skilled in the art, “additive manufacturing” refers to processes for forming a three-dimensional object by successively adding material to the object layer by layer. The three-dimensional object may be based upon a 3D model of the component object that may be electronically designed as part of an electronic file having the design parameters.

As used herein, “including,” “containing,” and like terms are understood in the context of this application to be synonymous with “comprising” and are therefore open-ended and do not exclude the presence of additional undescribed or unrecited elements, materials, phases, or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about.” Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

In this application, the use of the singular includes the plural and plural encompasses singular, unless specifically stated otherwise. In addition, in this application, the use of “or” means “and/or” unless specifically stated otherwise, even though “and/or” may be explicitly used in certain circumstances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. An expansion sleeve for receiving a tool shank, the expansion sleeve comprising:
a generally cylindrical body defining a longitudinal axis and comprising:
an inner wall;
an outer wall integrally formed with the inner wall; and
a pressurized fluid chamber located radially between and encapsulated in the inner wall and the outer wall; and
a front flange extending radially outward from the outer wall, wherein the front flange comprises a tool support connection structured and arranged to fasten the front flange to a tool support member.

2. The expansion sleeve of claim 1, wherein the pressurized fluid chamber comprises:
a generally cylindrical outer radial wall; and
a generally cylindrical inner radial wall radially inside and separated from the outer radial wall.

3. The expansion sleeve of claim 2, wherein the inner radial wall comprises:
a recessed front section;
a recessed rear section; and
a raised midsection located between the recessed front section and the recessed rear section along the longitudinal axis of the expansion sleeve.

4. The expansion sleeve of claim 1, wherein the pressurized fluid chamber comprises a primary chamber extending parallel with the longitudinal axis between the inner and outer walls and a secondary chamber extending radially outward from the primary chamber adjacent the front flange.

5. The expansion sleeve of claim 1, wherein the front flange is integrally formed with the outer wall of the expansion sleeve.

6. The expansion sleeve of claim 1, wherein the front flange is separately formed from the outer wall of the expansion sleeve.

7. The expansion sleeve of claim 6, wherein an outer surface of the outer wall of the expansion sleeve comprises at least one anti-rotation rib extending in a direction parallel with the longitudinal axis.

8. The expansion sleeve of claim 1, wherein an outer surface of the outer wall of the expansion sleeve is tapered radially inward along the longitudinal axis of the expansion sleeve from the front flange toward a rear edge of the expansion sleeve.

9. The expansion sleeve of claim 8, wherein the outer surface is tapered at an angle from 1° to 6°.

10. The expansion sleeve of claim 1, further comprising a pressurized fluid inlet port in fluid communication with the pressurized fluid chamber.

11. The expansion sleeve of claim 10, wherein the fluid inlet port extends axially into the pressurized fluid chamber.

12. The expansion sleeve of claim 10, wherein the fluid inlet port extends radially into the pressurized fluid chamber.

13. A hydraulic chuck assembly comprising:
a tool support member; and
an expansion sleeve inserted in the tool support member comprising:
a generally cylindrical body defining a longitudinal axis and comprising:
an inner wall;
an outer wall integrally formed with the inner wall; and
a pressurized fluid chamber located radially between and encapsulated in the inner wall and the outer wall; and
a front flange extending radially outward from the outer wall, wherein the front flange comprises a tool support connection structured and arranged to fasten the front flange to a tool support member.

14. The hydraulic chuck assembly of claim 13, wherein the front flange comprises a tool support connection structured and arranged to fasten the front flange to the tool support member.

15. The hydraulic chuck assembly of claim 13, wherein the front flange is integrally formed with the outer wall of the expansion sleeve.

16. The hydraulic chuck assembly of claim 13, wherein the front flange is separately formed from the outer wall of the expansion sleeve.

17. The hydraulic chuck assembly of claim 13, wherein an outer surface of the outer wall of the expansion sleeve comprises at least one anti-rotation rib extending in a direction parallel with the longitudinal axis, the tool support member comprises an axial bore having an inner surface, and the inner surface comprises at least one anti-rotation channel extending in a direction parallel with the longitudinal axis structured and arranged to receive the at least one anti-rotation rib.

18. The hydraulic chuck assembly of claim 13, wherein an outer surface of the outer wall of the expansion sleeve is tapered radially inward along the longitudinal axis of the expansion sleeve from the front flange toward a rear edge of the expansion sleeve, and the tool support member comprises an axial bore having an inner surface that is tapered radially inward along the longitudinal axis of the expansion sleeve from a tool receptacle front end to a bottom of the axial bore.

19. The hydraulic chuck assembly of claim 18, wherein the outer surface of the expansion sleeve is tapered at an angle from 1° to 6°.

20. The hydraulic chuck assembly of claim 18, wherein the inner surface of the axial bore is tapered at an angle from 1° to 6°.

21. The hydraulic chuck assembly of claim 18, wherein an interference fit is provided between the tapered outer surface of the outer wall of the expansion sleeve and the tapered inner surface of the axial bore.

22. The hydraulic chuck assembly of claim 13, wherein the tool support connection comprises at least one mechanical fastener.

23. The hydraulic chuck assembly of claim 13, wherein the tool support connection comprises external threads on an outside diameter of the flange threadingly engaging internal threads on an inner radial surface of an annular front recess of the tool support member.

24. The hydraulic chuck assembly of claim 23, further comprising a second set of external threads on an outside diameter of a cylindrical body of the expansion sleeve adjacent a rear edge of the expansion sleeve threadingly engaging a second set of internal threads on an inner radial surface of the tool support member.

25. The hydraulic chuck assembly of claim 13, wherein the expansion sleeve comprises a pressurized hydraulic fluid inlet port in flow communication with the pressurized fluid chamber.

26. The hydraulic chuck assembly of claim 25, further comprising an annular recessed fluid channel intersecting the inlet port and extending circumferentially around a radial outer surface of the outer wall of the expansion sleeve.

27. The hydraulic chuck assembly of claim 26, further comprising a radial seal ring extending circumferentially around the radial outer surface of the expansion sleeve.

28. The hydraulic chuck assembly of claim 27, wherein the radial seal ring is located axially forward or axially rearward of the annular recessed fluid channel along the longitudinal axis of the expansion sleeve.

29. The hydraulic chuck assembly of claim 13, wherein the tool support member comprises a pressurized fluid system comprising:
a pressurized fluid fill port in fluid communication with a pressurized fluid supply inlet;
a first pressurized fluid line in fluid communication with the pressurized fluid supply inlet; and
a second pressurized fluid line in fluid communication with the first pressurized fluid line and in fluid communication with the fluid inlet port of the expansion sleeve.

30. The hydraulic chuck assembly of claim 29, wherein the second pressurized fluid line is in fluid communication with an annular recessed fluid channel intersecting the inlet port and extending circumferentially around a radial outer surface of the outer wall of the expansion sleeve.

31. The hydraulic chuck assembly of claim 29, wherein the second pressurized fluid line extends radially in the tool support member, and the fluid inlet port of the expansion sleeve extends radially through the outer wall of the expansion sleeve.

32. The hydraulic chuck assembly of claim 29, wherein the second pressurized fluid line extends in a direction parallel with the longitudinal axis of the expansion sleeve, and the fluid inlet port of the expansion sleeve extends in a direction parallel with the longitudinal axis of the expansion sleeve through a rear edge of the expansion sleeve.

33. The hydraulic chuck assembly of claim 29, further comprising a ball seal with a central bore located between the second pressurized fluid line and the fluid inlet port of the expansion sleeve.

34. The hydraulic chuck assembly of claim 33, wherein the ball seal is seated in a seating bevel of the second pressurized fluid line and in a seating recess of the fluid inlet port of the expansion sleeve.

35. The hydraulic chuck assembly of claim 33, wherein the ball seal comprises steel and provides a metallic seal between the second pressurized fluid line and the inlet port of the expansion sleeve.
